(19) United States
(12) Patent Application Publication
(10) Pub. No.: US 2017/0066091 A1
(43) Pub. Date: Mar. 9, 2017

(54) FLUX AND PROCESS FOR REPAIR OF SINGLE CRYSTAL ALLOYS

(71) Applicant: Siemens Energy, Inc., Orlando, FL (US)

(72) Inventors: Gerald J. Bruck, Titusville, FL (US); Ahmed Kamel, Orlando, FL (US)

(21) Appl. No.: 14/847,093

(22) Filed: Sep. 8, 2015

(51) Int. Cl. B23K 35/36; B23K 26/70; B23K 26/342

(52) U.S. Cl. CPC B23K 35/3602; B23K 26/342; B23K 26/702

(57) ABSTRACT

A flux material that provides a heat outflow control layer of slag (30) on a melt pool (20) that suppresses lateral heat outflow (27) and facilitates uniaxial heat outflow (26A-D) from the melt pool at a rate that causes unidirectional crystallization in the melt pool to match a crystal direction (24) of a substrate (22). The slag may be insulative, and may flow to form a greater slag thickness (T2, T3) at the sides of the melt pool than at the middle (T1). The flux may contain constituents that warm the sides of the melt pool by exothermic reaction. The flux may be used in combination with insulating elements (32A-B, 38A-B, 44) placed on the substrate surface beside the melt pool and/or with supplemental heating of the sides of the weld.

### FIELD OF THE INVENTION

This invention relates generally to the field of metals joining, and more particularly to flux materials and welding methods useful for directionally solidified components such as single crystal superalloy gas turbine engine airfoils.

### BACKGROUND OF THE INVENTION

Gas turbine engines operate more effectively at higher temperatures. An increase of 56 degrees Celsius in a turbine's firing temperature can provide a corresponding increase of 8-13% in output and 2-4% of improvement in simple cycle efficiency. Therefore, advanced gas turbines use directionally solidified materials including single crystal superalloys with high temperature performance including creep resistance. Stray grains can form during single crystal component casting or through wear, fatigue, or creep during service, and can require the component to be scrapped or repaired. The repair of single crystal superalloys is problematic because of the tendency for stray grains to form during welding and for solidification cracks to occur.

Casting of single crystal (SX) alloys requires crystallographic selection from a directionally solidified seed crystal using a helical single crystal selector and unidirectional heat outflow to effect unidirectional solidification and SX extension. Lateral heat conduction and associated grain formation is avoided during casting by using refractory insulation and induction coils. This approach for directionally solidified and single crystal casting is taught for example by Gell, M. et al., “The Development of Single Crystal Superalloy Turbine Blades”, Pratt and Whitney Aircraft Group, published by The Minerals, Metal & Materials Society (TMS), 1980. Successful repair of SX components requires similar heat management. Avoidance of stray grain (SG) formation is essential during original casting as well as repair. A maximum temperature gradient (G) and minimum growth velocity (V) has been found effective in eliminating SG formation and attendant solidification cracking.

T. D. Anderson and J. N. Dupont describe in “Stray Grain Formation and Solidification Cracking Susceptibility of Single Crystal Ni-Base Superalloy CMSX-4”, American Welding Society, Welding Journal, 2011, reducing SG formation and associated cracking by utilizing high energy density processes such as electron beam (EB) welding. They conclude: “. . . EB process produces a higher temperature gradient that leads to reduced stray grains and less solidification cracking.”

FIG. 1 illustrates a relationship between a weld process travel speed and stray grain formation in electron beam welding and laser welding per Anderson et al. supra. Using high energy density at very low travel speeds, sufficient temperature gradient (G) and low growth rate (V) can be achieved such that low SG content results. Modest increases in travel speed have minimal affect on G but increase V, resulting in high SG content with a worst condition resulting at about 320 mm/min. Larger increases in travel speed produce larger G and, because G is a more dominant factor than V in affecting SG content, a progressively lower SG content results with further increases in travel speed. The highest travel speeds to minimize SG formation are of the order of 1500 mm/min. This exceeds most practical repair cladding. However, good results are also obtained at speeds on the order of 100 mm/min which is practical for repair processes.

Electron beam processing can produce a lower SG content than other energy delivery technologies, but it is uneconomical because of the requirement for high vacuum. Repetitive sequencing of components into a chamber, aligning them, and evacuating the chamber before processing is slow and inherently expensive. Another issue with electron beam processing is that top surface cooling is not controllable. In a vacuum there is radiative heat transfer but essentially no convection. Cooling is largely dictated by substrate conduction. Anderson et al. supra note that the top central region of the weld is prone to stray grain formation due to low G/V from a low thermal gradient where the temperature is distributed across the thickest region of the melt.

FIG. 2 illustrates heat outflow vectors 26, 27, 28, including lateral outflow 27, from a weld melt pool 20 on a surface 23 of a crystalline substrate 22 that has a single crystal preferred grain orientation 24. In the absence of lateral insulative or heat generating mechanisms used in casting (Gell et al. supra) cooling is dependent on convection and radiation 26 and conduction 27, 28. Even with a generally flat bead to maintain a constant G, lateral outflow promotes stray grains and lateral crystallization.

### BRIEF DESCRIPTION OF THE DRAWINGS

The invention is explained in the following description in view of the drawings that show:

FIG. 1 illustrates a known relationship between stray grain formation and weld process travel speed for electron beam welding and laser beam welding.

FIG. 2 is a sectional view of a prior art crystalline substrate with a welding melt pool undergoing both axial and non-axial heat outflow leading to stray grain formation.

FIG. 3 is a sectional view of a melt pool covered by slag of varying thickness that controls heat outflow.

FIG. 4 shows a melt pool for a second layer formed on top of a first layer.

FIG. 5 shows an embodiment as in FIG. 4 with insulative borders beside the slag.

FIG. 6 shows an embodiment as in FIG. 4 with insulative borders beside the melt pool.

FIG. 7 shows a melt pool in a repair excavation with insulation on the substrate surface beside the excavation to limit lateral heat outflow.

FIG. 8 shows a melt pool in a repair excavation with laser warming on the substrate beside of the excavation to limit lateral heat outflow.

FIG. 9 shows the embodiment of FIG. 8 after stopping the melting energy but continuing the substrate warming energy to limit lateral heat outflow.

FIG. 10 shows a melt pool in a bevel of a crystalline alloy substrate and an insulative barrier limiting liquid flow on a lower side of the melt pool.

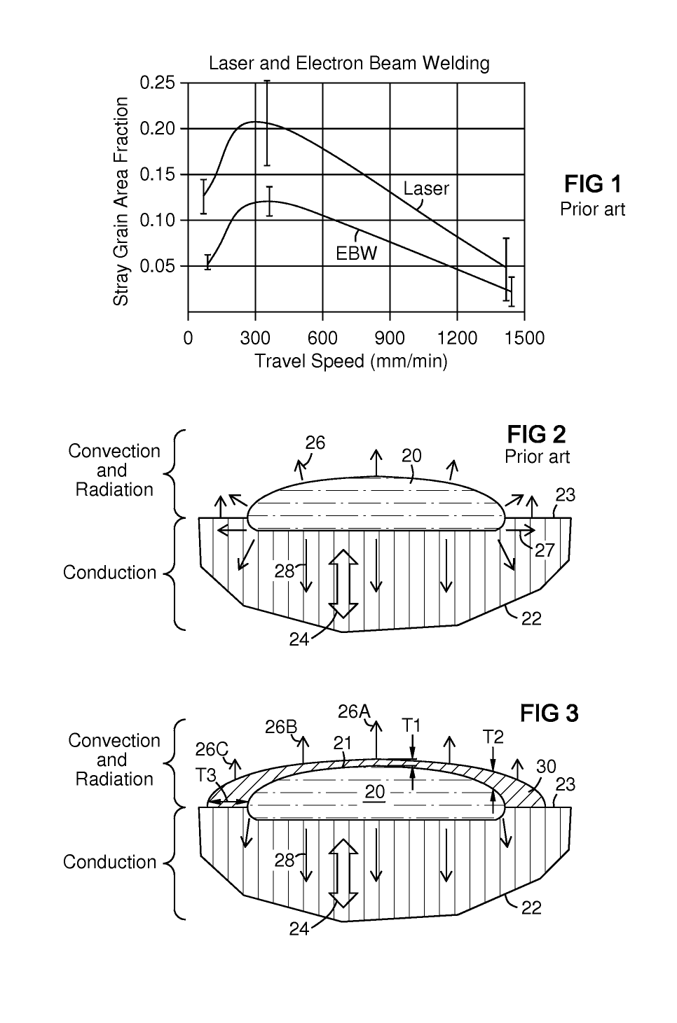

### DETAILED DESCRIPTION OF THE INVENTION

FIG. 3 shows a melt pool 20 with a convex free surface 21 on a crystalline substrate 22 that has a single crystal preferred grain orientation 24. Herein “free surface” means the surface of the melt pool not in contact with the substrate. Flux is added to the melt pool for example by mixing the flux with a powdered alloy filler material, or by forming composite particles of filler metal and flux, or by adding a flux layer above and/or below the filler metal, or by feeding flux and filler metal together as powders and/or via feed wires or other means. The flux is constituted to form an insulative slag 30 with a predetermined viscosity at the melt pool temperature (i.e. at temperatures of the slag when the melt pool is liquid) that causes the flux to flow into a heat outflow control geometry with a first thickness T1 normal to the melt pool surface over a center of the melt pool, a second normal thickness T2 of at least twice the first thickness above all sides of the melt pool, and a third lateral thickness T3 of at least 4 times the first thickness around all sides of the melt pool as measured adjacent to and parallel to the substrate surface 23. In one embodiment, thickness T1 is no greater than 0.5 mm. This geometry is created by constituting the flux for adequate fluidity on the melt pool. For example the flux may be constituted with certain proportions of CaF₂ and similar fluorides, including but not limited to Na₃AlF₆, K₂ZrF₆, NaF, BaF₂, LiF, MgF₂, and StF₂. The slag geometry controls the heat outflow vectors 26A-C differentially across the melt pool to maintain substantially uniaxial heat outflows from the melt pool.

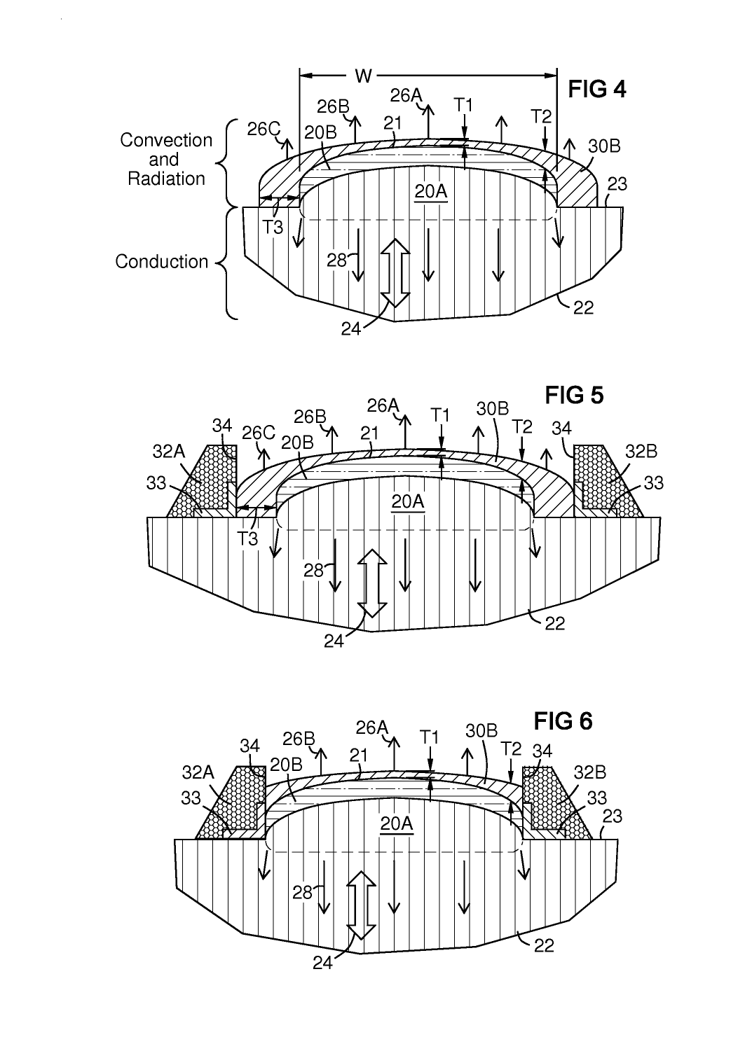

FIG. 4 shows a melt pool 20B for a second layer formed on top of the first layer 20A now solidified as a single crystal extension of the substrate 22 and with original slag layer 30 removed. Slag 30B provides a blanket of insulation of varying thickness on the second melt pool to manage heat outflow. Laser energy can be modulated across the width W of the melt pool to effect melting of preplaced powder, and fusion to the underlying substrate, as well as formation of slag to the sides of the deposit thereby effecting lateral insulation. Surface tension of molten metal and of molten slag and physical containment by way of solidified slag all act to define the lateral geometry of the final solidified metal deposit. The surface tension of molten metal may be high enough, the slag viscosity may be high enough, the slag fluidity may be low enough and the slag solidification temperature may be low enough that the side areas T3 build-up vertically as shown due to slag solidification from the substrate surface upward.

FIG. 5 shows a melt pool 20B for a second layer formed on top of the first layer 20A now solidified as a single crystal extension of the substrate 22. This embodiment is useful for slag with a viscosity too low, or fluidity too high, or solidification temperature too high to support the vertical side build-up areas T3 of FIG. 4. Slag 30B provides a blanket of insulation of varying thickness on the second melt pool to manage heat outflow. Refractory insulating elements 32A-B may laterally border the slag 30B to limit lateral flow of the slag and to further provide lateral heat insulation, either on all layers or only on the second and subsequent layers as needed. Such insulating elements may be made for example of alumina and/or zirconia foam with at least one closed-cell surface 34. Alternately, sintered alumina and/or zirconia powder or loose powder may be used. Such insulative elements may also include integral heating elements 33 for additional energy management.

FIG. 6 shows a melt pool 20B for a second layer formed on top of the first layer 20A now solidified as a single crystal extension of the substrate 22. Slag 30B provides a blanket of insulation of varying thickness on the second melt pool to manage heat outflow. Refractory insulating elements 32A-B may surround the melt pools 20A, 20B to limit lateral flow of melt pools and slag for both layers, or such elements may be used only on the second and subsequent layers as needed. The insulating elements may be for example refractory foam blocks of alumina and/or zirconia, and may have at least one closed-cell surface 34. Alternately, sintered alumina and/or zirconia powder or loose powder may be used. Such insulative elements may also include integral heating elements 33 for additional energy management.

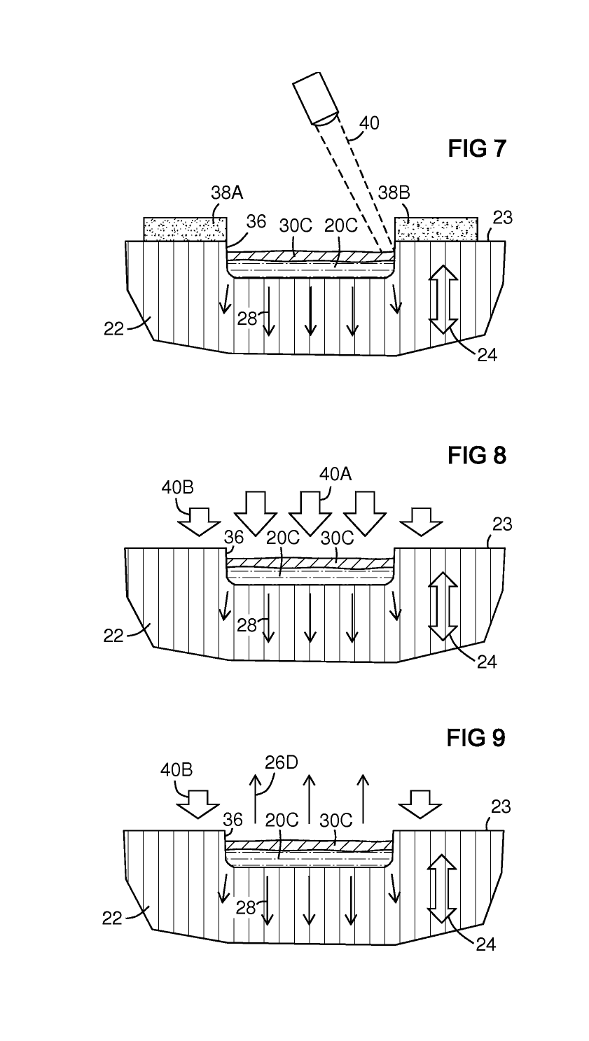

FIG. 7 shows a melt pool 20C in a repair excavation 36 in a surface 23 of a crystalline alloy substrate 22 with a single crystal preferred grain orientation 24. Slag 30C on the melt pool may be constituted to be more thermally conductive and/or to have higher emissivity than the melt pool. Insulating elements 38A, 38B are disposed immediately beside and around the excavation to block radiation and convection therefrom. The insulating elements may be formed of an insulating powder such as zirconia, or refractory foam blocks of zirconia and/or alumina. In one embodiment a single powdered flux material may be used for both the lateral insulation 38A-B and the central conductive/emissive slag 30C where the flux powder is insulative in powder form and conductive/emissive when molten. The laser beam 40 may be directed to melt only the portion of the flux in the excavation.

FIG. 8 shows a melt pool 20C in a repair excavation 36 in a surface 23 of a crystalline alloy substrate 22 with a single crystal preferred grain orientation 24. Slag 30C on the melt pool may be constituted to be more thermally conductive and/or to have higher emissivity than the melt pool. Laser energy may be applied at a melting level 40A to additive alloy material and flux in the excavation to form the melt pool 20C, and at a lesser warming level 40B to the substrate surface 23 beside the melt pool to suppress or slow lateral heat outflow from the melt pool. As shown in FIG. 9, the side energy 40B may be applied after, or continued after, the melt energy 40A is removed. Alternately, or in addition, the energy 40B may be applied as preheat energy and before melt energy 40A is introduced. The side energy may be gradually decreased as the melt pool cools to maintain zero lateral heat outflows over a crystal growth time. This provides uniaxial heat outflows 26D at a rate controlled by the flux composition and thickness.

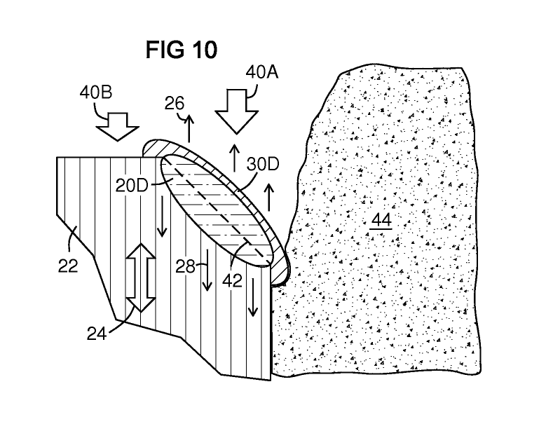

FIG. 10 shows a melt pool 20D in a bevel 42 of a crystalline alloy substrate 22 with a single crystal preferred grain orientation 24. An insulative barrier, such as a powder, sintered powder, or refractory foam block of material 44 such as alumina and/or zirconia may border and contain the slag at the downhill side of the bevel. Slag 30D on the melt pool is constituted to flow into a geometry with differing thickness as previously described. The need for such physical containment is a function of surface tension and gravitational forces acting to affect geometry of the liquids of melt pool and slag as well as the need to maintain heat flow parallel to grain orientation 24. Laser energy may be applied at a melting level 40A to additive alloy material or to the substrate surface 23 to form the melt pool 20D. A lesser warming level of laser energy 40B may be applied to the substrate beside the melt pool to minimize lateral heat outflow from the melt pool. Additionally, a lesser warming level of laser energy and/or supplemental heating may be applied to insulative material 44 to minimize lateral heat outflow. The side energy 40B may be applied before, after, or continued after the melt energy 40A is removed. The side energy may be gradually decreased as the melt pool cools to maintain zero lateral heat flow.

Materials for the above described fluxes may be divided into those providing insulative slag and those providing conductive and/or radiative slag. The insulative, conductive and spectrally emissive properties of molten slag are specifically important in this context because shortly after the slag solidifies the underlying metal solidifies and grain orientation is thereafter fixed. The thermal conductivity of molten slags has been reported to increase with increasing silica (SiO₂) content. (Ref. Mills, K., The Estimation of Slag Properties, Dept. of Materials—Imperial College, UK, March 2011.) The effect is related to slag structure and involves phonon conduction. So, a flux with high silica content is useful in conductive molten slag embodiments. Attempts to study conductivity of molten slags of other composition have been experimentally difficult. Higher amounts of CaF₂ have been reported to have higher thermal conductivity—relative to combination with CaO but the data is limited. (Ref. Commission of the European Communities, Physical Properties of Slags EUR 7292EN, 1981.) So, a flux with relatively high CaF₂ content and low CaO content may also be useful in conductive molten slag embodiments. The value of emissivity of CaF₂ in the liquid phase is about 0.97. The value of emissivity is only slightly lowered with the addition of Al₂O₃ but is significantly reduced with the addition of MgO. (Ref. Commission of the European Communities, Physical Properties of Slags EUR 7292EN, 1981.) So, fluxes with high CaF₂, high Al₂O₃ and low MgO contents are useful in conductive and radiative slag embodiments.

An exemplary flux for a molten conductive/radiative slag may comprise:
10-60 wt. % CaF₂ for fluidity, thermal conductivity and emissivity;
10-60 wt. % SiO₂ for thermal conductivity;
10-60 wt. % Al₂O₃ for emissivity;
less than 10 wt. % MgO to preserve emissivity; and
less than 10 wt. % CaO to preserve conductivity.

An exemplary flux for an insulative molten slag may comprise:
10-60 wt. % total of at least one of CaF₂ CaO, and MnO as fluidizers to enhance slag distribution and thickening at deposit edges to improve lateral insulation;
10-60 wt. % total of at least one of ZrO₂ and CaO as insulative constituents;
less than 20 wt. % SiO₂ to minimize negative effects on insulation and fluidity;
less than 30 wt. % Al₂O₃ for slag structural building without excessively increasing thermal conductivity relative to ZrO₂ and CaO; and
less than 10 wt. % MgO to avoid excess thermal conductivity.

Some flux constituents can dissociate in the hotter regions of processing and can reform or form new compounds in the cooler regions of processing. Such reformations can be exothermic. To the extent that they concentrate at the edges of a deposit, such heat release can effectively limit lateral heat outflow. This can be an alternate or addition to the lateral laser warming 40B described previously. CaO can react with water vapor adjacent or above the deposit, forming Ca(OH)₂ and releasing heat. Thus in one embodiment it is beneficial to include up to 15 wt. % of CaO in the flux composition.

This invention solves the challenge of avoiding stray grain formation and maintaining crystallographic orientation during repair of single crystal alloys. The specialized flux compositions and associated heat control methods herein produce successful laser repairs for single crystal alloys. It is beneficial to use flux as taught herein instead of inert gas for deposition of single crystal alloys, because the flux can control the heat outflow vectors differentially across the melt pool to provide substantially uniaxial heat outflow.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A flux useful during the deposition of a layer of an alloy material onto a surface of a substrate having a unidirectional crystalline structure by the melting and re-solidification of the alloy material on the surface in the presence of the flux, the flux characterized by a composition that facilitates solidification of the alloy material as a crystalline extension of the substrate by minimizing lateral heat outflow and facilitating uniaxial heat outflow from a melt pool of the alloy material.

2. The flux of claim 1, wherein the flux is constituted to create a thermally insulating slag of a predetermined viscosity, at a liquid temperature of the melt pool, effective to cause the slag to form a heat outflow control geometry on a free surface of the melt pool as seen in a cross section through the melt pool, wherein the heat outflow control geometry comprises a first thickness of the slag over a center of the melt pool, and a second thickness of the slag of at least twice the first thickness above a side of the melt pool.

3. The flux of claim 2, wherein the heat outflow control geometry further comprises a third lateral thickness of at least 4 times the first thickness around all sides of the melt pool as measured adjacent to and parallel to the substrate.

4. The flux of claim 2, wherein the first thickness is not more than 0.5 mm.

5. The flux of claim 2, wherein the composition contains:
10-60 wt. % total of at least one of CaF₂ CaO, and MnO;
10-60 wt. % total of at least one of ZrO₂ and CaO;
less than 20 wt. % SiO₂;
less than 30 wt. % Al₂O₃; and
less than 10 wt. % MgO.

6. The flux of claim 2, wherein the composition comprises 10-15 wt. % of CaO for exothermic reaction.

7. The flux of claim 1, wherein the composition comprises:
10-60 wt. % CaF₂ for fluidity, thermal conductivity and emissivity;
10-60 wt. % SiO₂ for thermal conductivity;
10-60 wt. % Al₂O₃ for emissivity;
less than 10 wt. % MgO to preserve emissivity; and
less than 10 wt. % CaO to preserve conductivity.

8. The flux of claim 7, wherein the composition comprises 10-15 wt. % of CaO for exothermic reaction.

9. A method comprising:
composing a flux material that provides a heat outflow control layer of slag on a melt pool, wherein the slag facilitates uniaxial heat outflows from the melt pool;
depositing an alloy material and the flux material onto a surface of an alloy substrate having a unidirectional crystalline structure;
melting the deposited alloy material and flux material to form the melt pool covered by the layer of slag; and
cooling the melt pool by uniaxial heat outflows aligned with the unidirectional crystalline structure of the substrate at a cooling rate effective to form a solidified layer of the alloy material as a crystalline extension of the substrate.

10. The method of claim 9, further comprising forming the melt pool with a convex free surface, and constituting the flux material to provide a viscosity of the slag at a liquid temperature of the melt pool wherein the slag flows on the convex free surface to become at least twice as thick at sides of the melt pool as at a middle of the melt pool.

11. The method of claim 10, further comprising composing the slag to exhibit a liquid viscosity during the melting step effective to flow on the convex free surface to form a slag thickness of less than 0.5 mm thick in the middle of the melt pool and greater than 1 mm thick at the sides of the melt pool.

12. The method of claim 9 further comprising:
forming an excavation in the surface of the substrate;
depositing the alloy material as a first powder in the excavation;
depositing the flux material as a second powder on the alloy material and on the surface of the substrate beside the excavation; and
directing a laser energy to melt the first and second powders in the excavation, but not to melt the second powder beside the excavation.

13. The method of claim 9 further comprising:
forming an excavation in the surface of the substrate;
depositing the alloy material and the flux material in the excavation;
placing an insulating element on the surface of the substrate beside the excavation; and
directing a laser energy to melt the alloy and flux materials in the excavation.

14. The method of claim 13 further comprising integrating a heater with the insulating element, and warming the substrate with the heater beside the melt pool to facilitate the substantially uniaxial heat outflow from the melt pool.

15. The method of claim 9 further comprising disposing a refractory insulating element on the surface of the substrate immediately beside the melt pool.

16. The method of claim 15 further comprising integrating a heater with the insulating element, and warming the substrate with the heater beside the melt pool to facilitate the substantially uniaxial heat outflow from the melt pool.

17. The method of claim 9, further comprising composing the flux material to comprise a material which provides an exothermic reaction in the layer of slag.

18. The method of claim 9, further comprising composing the flux material to comprise 10-15 wt. % CaO.

19. The method of claim 9, further comprising composing the flux material to comprise:
10-60 wt. % total of at least one of CaF₂ CaO, and MnO;
10-60 wt. % total of at least one of ZrO₂ and CaO;
less than 20 wt. % SiO₂;
less than 30 wt. % Al₂O₃; and
less than 10 wt. % MgO.

20. The method of claim 9, further comprising composing the flux material to comprise:
10-60 wt. % CaF₂ for fluidity, thermal conductivity and emissivity;
10-60 wt. % SiO₂ for thermal conductivity;
10-60 wt. % Al₂O₃ for emissivity;
less than 10 wt. % MgO to preserve emissivity; and
less than 10 wt. % CaO to preserve conductivity.
